(19) United States
(12) Patent Application Publication
(10) Pub. No.: US 2026/0159365 A1
(43) Pub. Date: Jun. 11, 2026

(54) A PALLET HANDLING SYSTEM AND A METHOD FOR HANDLING PALLETS

(71) Applicant: MOBILE INDUSTRIAL ROBOTS A/S, Odense SØ (DK)

(72) Inventors: Sigurd Birk HJULER, Odense C (DK); Mikkel Steen PEDERSEN, Silkeborg (DK); Bjørn Bøgesvang HOULBJERG, Odense SØ (DK); Kenneth Bruun HENRIKSEN, Kerteminde (DK)

(21) Appl. No.: 18/704,351

(22) PCT Filed: Mar. 29, 2023
(86) PCT No.: PCT/EP2023/058089

§ 371 Date: Apr. 24, 2024

(30) Foreign Application Priority Data
Apr. 20, 2022 (EP) 22169033.2

(51) Int. Cl. B66F 9/06; B66F 7/28; B66F 9/22; B66F 9/24

(52) U.S. Cl. CPC B66F 9/06; B66F 7/28; B66F 9/22; B66F 9/24

(57) ABSTRACT

Disclosed is a pallet handling system (1) comprising a pallet rack (2) including three support means (3, 4, 5) being parallel in a longitudinal direction of the three support means (3, 4, 5), wherein each of the three support means (3, 4, 5) comprises one or more upper support surfaces (6) being substantially horizontally level. The three support means (3, 4, 5) are connected to one or more support structures (7) arranged for suspending the three support means (3, 4, 5) above a ground level (20), wherein the three support means (3, 4, 5) comprises first support means (3), second support means (4) and third support means (5) of which the second support means (4) are arranged between the first and third support means (5). The second support means (4) are formed as a lever having a second support connection end (8) being connected to at least one of the one or more support structures (7) and a second support free end (9) and wherein said second support means (4) has a width (SSW) of between 140 and 5 mm and preferably between 120 and 20 mm. The pallet handling system (1) also includes an automated guided vehicle (10) comprising a pallet lifting device (11) having at least two upper lifting surfaces (12, 13), wherein the at least two upper lifting surfaces (12, 13) are separated by a slit (14) along a middle part of the pallet lifting device (11) so that a first upper lifting surface (12) of the at least two upper lifting surfaces (12, 13) fits between the first support means (3) and the second support means (4) and so that a second upper lifting surface (13) of the at least two upper lifting surfaces (12, 13) fits between the second support means (4) and the third support means (5), and wherein the slit (14) is arranged to accommodate the second support means (4). A method for handling pallets (21) is also disclosed.

### BACKGROUND OF THE INVENTION

The invention relates to a pallet rack comprising support means for supporting a pallet and an automated guided vehicle comprising a pallet lifting device. The invention also relates to a method for handling pallets by way of a pallet rack and an automated guided vehicle comprising a pallet lifting device.

### DESCRIPTION OF THE RELATED ART

Automated guided vehicles or automatic guided vehicles (AGV) are used more and more in industry, warehouses and other for automating the handling of goods and products. An AGV is a portable self-propelled robot that follows along marked long lines or wires on the floor, and/or uses radio waves, vision cameras, magnets, lasers or the like for navigation. AGV's having means for autonomous route re-planning are also called autonomous mobile robots (AMR).

I.e. from the European patent application EP 3 656 702 A1 it is known to provide an AGV with a lifting device on the top face enabling that the AGV may pick up and place EUR-pallets (also known as Euro-pallet or EPAL-pallet (800×1200 mm)) on a pallet rack by lifting the pallets on the underside of the top deck boards of the pallet (i.e. between the three parallel runners supporting the pallet on the ground) and placing the pallets on the pallet rack so that the bottom deck boards of the two outer runners are supported by parallel supports on the pallet rack. However, this pallet handling system has its limitations. First of all it is difficult to use this system for handling both EUR-pallets and the most common type of US-pallet. The most common type of US-pallet is 40×48 inches (˜1016×1219 mm) and the three bottom deck boards are extending across the 1016 mm, meaning that if the US-pallet is lifted on the underside of the top deck boards between the bottom deck boards, the pallet is 1219 mm across the traveling direction-which is undesirable due to space requirements and the risk of the pallet including its load tilting when traveling through corners. Furthermore, to enable that the pallets may be lifted directly of the AGV by means of a forklift or the like, the vertical travel of the lifting device has to be relatively long to enable sufficient space and it is expensive and complex to form a lifting device that is compact and at the same time has sufficient travel and lifting force.

An object of the invention is therefore to provide for a pallet handling system and method alleviating the above mentioned problems.

### The Invention

The invention provides for a pallet handling system comprising a pallet rack including three support means being parallel in a longitudinal direction of the three support means, wherein each of the three support means comprises one or more upper support surfaces being substantially horizontally level. The three support means are connected to one or more support structures arranged for suspending the three support means above a ground level, wherein the three support means comprises first support means, second support means and third support means of which the second support means are arranged between the first and third support means. The second support means are formed as a lever having a second support connection end being connected to at least one of the one or more support structures and a second support free end, and wherein the second support means has a width of between 140 and 5 mm and preferably between 120 and 20 mm. The pallet handling system also includes an automated guided vehicle comprising a pallet lifting device having at least two upper lifting surfaces, wherein the at least two upper lifting surfaces are separated by a slit along a middle part of the pallet lifting device so that a first upper lifting surface of the at least two upper lifting surfaces fits between the first support means and the second support means and so that a second upper lifting surface of the at least two upper lifting surfaces fits between the second support means and the third support means, and wherein the slit is arranged to accommodate the second support means.

Providing the pallet rack with three support means is advantageous in that this ensures that EUR-pallets are supported by the pallet rack in a way by which the pallet is better supported, in that the weight of the pallet-including the load placed on the pallet-is supported both along the two outer runners of the pallet by means of the first and third support means and along the middle runner therebetween by means of the second support means. Furthermore, the middle runner on a EUR-pallet is typically around 145 mm wide and by forming the second support means between 140 and 5 mm wide and preferably between 120 and 20 mm wide-i.e., more narrow than the width of the middle runner on an EUR-pallet-it is possible for the AGV to lift the EUR-pallet of the pallet rack by contacting the EUR-pallet on the underside of all three runners. However, if the second support means are too wide it becomes too difficult to ensure that at least one of the first upper lifting surface and the second upper lifting surface makes contact with the middle runner of the EUR-pallet when lifting the pallet of the pallet rack. And if the second support means are too narrow it will be difficult to ensure that the second support means are strong enough to sufficiently support a fully loaded pallet. Thus, the present width ranges ensure an advantageous relationship between functionality and durability. Note that the term width is this context is the direction perpendicular to the longitudinal direction of the three support means.

The pallet handling system according to the present invention also ensures that US-pallets may be placed on the pallet rack with the three bottom boards extending across the longitudinal extent of the three support means so that the pallet is better supported by the pallet rack and so that the AGV may lift the US-pallet of the pallet rack with the narrowest extent of the US-pallet across the traveling direction of the AGV. Forming the pallet rack and the AGV so that both EUR-pallets and US-pallets are lifted and supported on the underside of the bottom decks of the pallets is advantageous because the pallets are designed to be supported on these surfaces and the risk of deforming the pallets or even breaking them due to only supporting them in extreme positions is severely reduced. Furthermore, forming the lifting pallet handling system so that both EUR-pallets and US-pallets are lifted on the underside of the bottom decks is advantageous in that this enables that the pallets may be lifted directly of the AGV without the pallet lifting device having to contract which ensures a simpler and more inexpensive pallet lifting device and enables simpler logistic (in that pallets do not necessarily always have to be delivered to pallet racks) and faster repair in case of AGV breakdown—in that the pallet including load can be easily removed by means of a forklift. Even further, forming the second support means as a lever is advantageous in that this ensures that the second support means can be formed strong and rigid without getting in the way of the AGV when it is traveling in and out from under the pallet rack. Furthermore, forming the pallet lifting device on the AGV with a slit arranged to accommodate the second support means is advantageous in that it hereby is possible to lift the pallet of the pallet rack without interfering with the second support means while still ensuring that at least one of the upper lifting surfaces of the pallet lifting device makes contact with the middle runner of a EUR-pallet when lifting it of the pallet rack by means of the AGV.

It should be emphasised that the term “support means” is to be understood as any kind of support capable of supporting a pallet placed on the pallet rack. I.e. the term includes any kind of rails, forks, bars or similar. It should also be noted that the support means does not necessarily have to be arranged to support the pallet over the full length of the support means. In one embodiment the support means could comprise several individual support surfaces being directly or indirectly interconnected over the length of the support means.

Furthermore, in this context the term “pallet lifting device” is to be understood as any kind of a pallet lifter capable of lifting and lowering a pallet and capable of being arranged on top of an automated guided vehicle. I.e., the term includes any kind of hydraulic lift, pneumatic lift, electrical actuator lift, scissor lift, jack lift or other or any combination thereof.

Furthermore, please note that any reference to orientation throughout this document i.e. up, down, upper, bottom, width etc.—is made in relation to the pallet handling system during normal use.

In an aspect of the invention, the slit has a width which is between 5 and 140 mm wider and preferably between 10 and 120 mm wider than the second support means.

If the slit is too wide in relation to the width of the second support means the risk chance of at least one of the two upper lifting surfaces of the pallet lifting device making contact with the middle runner when lifting an EUR-pallet is too little. However, if the slit is too narrow in relation to the width of the second support means it will be very difficult to navigate the raised pallet lifting device out of the pallet rack without the pallet lifting device colliding with the second support means or even wedging in the process. Thus, the present width ranges of the slit are advantageous in relation to functionality of the pallet handling system. Note that width in this context is the direction perpendicular to the longitudinal direction of the support means.

In an aspect of the invention, an internal distance between the first and third support means is between 780 and 605 mm and preferably between 750 and 620 mm.

If the internal distance between the first and third support means—i.e., the distance perpendicular to the longitudinal direction of the three support means—is too long it will be difficult to support an 800 mm wide EUR-pallet properly on both the first and third support means on the pallet rack. And if the internal distance between the first and third support means is too little it will be difficult to support both outer runners of the EUR-pallet by the pallet lifting device of the AGV. Thus, the present distance ranges are advantageous in relation to proper support of the EUR-pallet both on the pallet rack and the pallet lifting device.

In an aspect of the invention, the length of the three support means is between 700 and 1,600 mm and preferably between 800 and 1,300 mm in the longitudinal direction.

If the length of the three support means is too short the pallets are nor properly supported on the pallet rack and the risk of an unevenly loaded pallet tipping of the pallet rack is increased. However, if the length of the three support means is too long it becomes more difficult to navigate a loaded AGV in and out of the pallet rack and the cost of the pallet rack becomes too high. Thus, the present length ranges are advantageous in relation to functionality of the pallet handling system. Note that the length is measured in the longitudinal direction of the support means In an aspect of the invention, each of the upper lifting surfaces are between 255 and 385 mm and preferably between 280 and 360 mm wide, and wherein each of the upper lifting surfaces are between 200 and 1,400 mm and preferably between 500 and 1,200 mm long, wherein the length is measured in the longitudinal direction of the support means and the width is perpendicular to the length.

If the upper lifting surfaces are too wide, the three support means will have to be formed very narrow to ensure that the upper lifting surfaces may pass up between the three support means thereby reducing the support of the pallet on the pallet rack. However, if the upper lifting surfaces are too narrow the support of the upper lifting surfaces is reduced when lifting the pallet and the present width ranges are therefore advantageous in relation to support of the pallet both on the pallet rack and the pallet lifting device. Furthermore, if the upper lifting surfaces are too short the risk of the pallet tipping while being support by the pallet lifting device increase and if the upper lifting surfaces are too long, the pallet lifting device becomes too big and expensive. Thus, the present length ranges are therefore advantageous in relation to support of the pallet and cost.

In an aspect of the invention, the second support means is located in the middle between the first and third support means.

Locating the second support means in the middle between the first and third support means is advantageous in that this ensures that EUR-pallet may be supported symmetrically on the pallet rack while also ensuring that the middle runner of the EUR-pallet may be supported by both upper lifting surfaces on either sides of the second support means, whereby symmetrically support on the pallet lifting device is also ensured. Supporting the EUR-pallet symmetrically is advantageous in that this enables a more evenly distributed support of the pallet and reduces the risk of the pallet tipping over and reduces the risk of deforming or damaging the pallet.

In an aspect of the invention, each of the least two upper lifting surfaces are formed by a lifting plate placed on a lifting pedestal, wherein a maximum width of the lifting plate it greater than a maximum width of the lifting pedestal.

Usually, the pallet rack is placed against a wall or even hung on a wall and the AVG therefore has to exit from under the pallet rack in the same direction it entered. However, when the AGV changes the traveling direction 180 degrees, the AGV can wobble a little from side to side and the risk of the pallet lifting device hitting the three support means when reversing out with a pallet on a raised pallet lifting device is thereby increased. It is therefore advantageous to form each of the least two upper lifting surfaces by a lifting plate placed on a lifting pedestal, wherein a maximum width of the lifting plate it greater than a maximum width of the lifting pedestal, in that the lifting plate hereby can be formed wide to ensure sufficient support of the pallet while the more narrow lifting pedestal ensures more clearance to the three support means when the lifting plate is lifted above the upper surface of the support means.

In an aspect of the invention, the first support means and the third support means comprises one or more widthwise indentations at the sides facing each other and wherein the least two upper lifting surfaces comprises one or more widthwise protrusions extending into the one or more widthwise indentations.

Forming the first and the third support means with indentations along the inside side faces corresponding to protrusions on the outside side faces of the least two upper lifting surfaces is advantageous in that this enables that particularly the EUR-pallet may be supported over more of the width of the outer runners both on the pallet rack and when being lifted by the pallet lifting means. Thereby the risk of local deformation or damage to the pallet—particularly when the pallet is heavily loaded—is reduced and the pallet is supported closer to the periphery on the pallet lifting device hereby reducing the risk of the pallet tipping of the AGV when being moved around.

In an aspect of the invention, the pallet lifting device comprises first lifting means arranged to actuate the first upper lifting surface and second lifting means arranged to actuate the second upper lifting surface.

Forming the upper lifting surfaces with individual lifting means is advantageous in that this enables a more versatile pallet lifting means. It should be noted that this does not preclude that the individual lifting means are driven by the same lifting drive (i.e. same hydraulic pump, same electrical motor or the like).

In an aspect of the invention, the three support means are interconnected by the one or more support structures.

Forming the pallet rack so that the three support means are connected to each other by the one or more support structures is advantageous in that this ensures a more stable construction and that the pallet rack is formed as a single unit that may more easily be moved around.

In an aspect of the invention, the three support means are integrally formed and wherein the one or more support structures comprises legs suspending the three support means above the ground level.

Forming the three support means as a single coherent unit is advantageous in that this simplifies manufacturing and subsequent handling. And supporting the three integrally formed support means by means of legs ensures a simple design that is easy to handle and erect.

The invention further provides for a method for handling pallets, the method comprising the steps of:
placing a pallet comprising three bottom decks on a pallet rack so that the three bottom decks are supported above a ground level by three substantially level support means of the pallet rack, wherein the three support means are parallel in an longitudinal direction of the three support means, wherein the three parallel support means comprises first support means, second support means and third support means of which the second support means are arranged between the first and third support means, wherein the second support means are formed as a lever having a second support connection end being connected to at least one of the one or more support structures and a second support free end, and wherein the second support means has a width of between 140 and 5 mm and preferably between 120 and 20 mm,
guiding an automated guided vehicle comprising a pallet lifting device in under the pallet supported by the pallet rack in a direction substantially parallel with the longitudinal direction,
raising a first upper lifting surface of the at least two upper lifting surfaces of the pallet lifting device up between the first support means and the second support means and raising a second upper lifting surface of the at least two upper lifting surfaces of the pallet lifting device up between the second support means and the third support means so that the first upper lifting surface and the second upper lifting surface makes contact with the three bottom decks of the pallet and lifts the pallet of the first support means, the second support means, and the third support means, and
guiding the automated guide vehicle comprising the pallet lifting device and the pallet away from the pallet rack in a direction substantially parallel with the longitudinal direction.

Placing the pallet on the pallet rack so that the three bottom decks are supported by the three level support means of the pallet rack is advantageous in that the pallet hereby is better and more uniformly supported on the pallet rack. And lifting the pallet of the pallet rack by means of at least two upper lifting surfaces of the pallet lifting device extending up between the three support means to make contact with the three bottom decks of the pallet is advantageous in that the pallet hereby is also better and more uniformly supported on the pallet lifting device and in that lifting the pallet on the three bottom decks enables that the pallet may be lifted of the AGV e.g. by means of a forklift without contracting the pallet lifting device.

In an aspect of the invention, the pallet comprises a first runner having a first runner bottom deck extending along a first side of the pallet, a third runner having a third runner bottom deck extending along an opposite side of the pallet and a second runner having a second runner bottom deck extending along a middle of the pallet parallel to the first runner and the third runner and wherein the pallet is placed on the pallet rack with the second runner bottom deck aligned with and on top of the second support means.

Placing an EUR-pallet so that the bottom deck of the middle runner—i.e., the second runner—is aligned with and on top of the second support means is advantageous in that the pallet is hereby better supported on the pallet rack and in that this enables that the second runner bottom deck may be supported by both the first support means and the second support means when the pallet lifting device lifts the pallet of the pallet rack-hereby ensuring better support of the pallet on the pallet lifting device.

In an aspect of the invention, both the first upper lifting surface and the second upper lifting surface makes contact with the second runner bottom deck when the first upper lifting surface and the second upper lifting surface are raised.

Supporting the second runner bottom deck by means of both the first upper lifting surface and the second upper lifting surface when the pallet lifting device lifts the pallet of the pallet rack is advantageous in that this ensures better and more uniform support of the pallet on the pallet lifting device thereby reducing the risk of local deformation or damage to the pallet.

In an aspect of the invention, each of the at least two upper lifting surfaces are formed by a lifting plate placed on a lifting pedestal, wherein a maximum width of the lifting plate it greater than a maximum width of the lifting pedestal and wherein first upper lifting surface and the second upper lifting surface are raised until a bottom surface of the lifting plates are higher than the three support means before guiding the automated guided vehicle comprising the pallet lifting device and the pallet away from the pallet rack.

Raising the bottom surface of the lifting plates above the three support means before guiding the automated guided vehicle (AGV) away from the pallet rack is advantageous in that this enables more clearance between the pallet lifting device and the three support means while at the same time enabling a larger contact surface between the bottom decks of the pallet and the lifting surfaces when the maximum width of the lifting plate it greater than a maximum width of the lifting pedestal.

In an aspect of the invention, the method discussed in the above is for handling pallets by way of a pallet handling system according to any of the previously discussed pallet handling systems.

Hereby is achieved an advantageous embodiment of the invention.

### FIGURES

The invention will be described in the following with reference to the figures in which

FIG. 1 illustrates a pallet handling system lifting an EUR-pallet, as seen in an isometric view,

FIG. 2 illustrates a pallet handling system lifting a US-pallet, as seen in an isometric view,

FIG. 3 illustrates a pallet rack, as seen in an isometric view,

FIG. 4 illustrates a pallet rack, as seen from the top,

FIG. 5 illustrates a pallet lifting device, as seen in an isometric view,

FIG. 6 illustrates a pallet lifting device, as seen from the top,

FIG. 7 illustrates a pallet handling system with a pallet lifting device in lifted position, as seen in an isometric view,

FIG. 8 illustrates a pallet handling system with a pallet lifting device in lowered position, as seen in an isometric view,

FIG. 9 illustrates a pallet handling system with an EUR-pallet in lowered position, as seen from the front, and

FIG. 10 illustrates a pallet handling system with an EUR-pallet in lifted position, as seen from the front.

### DETAILED DESCRIPTION OF RELATED ART

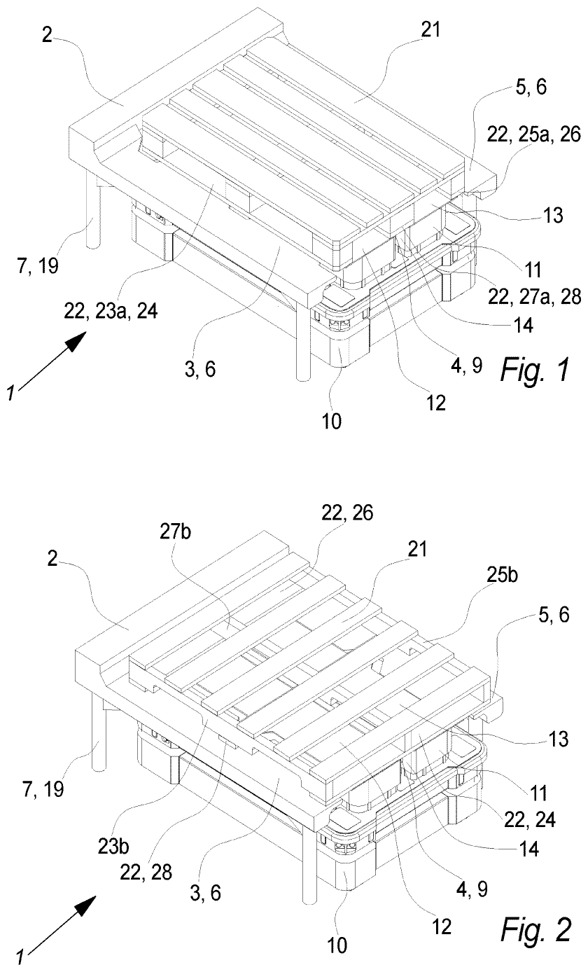

FIG. 1 illustrates a pallet handling system 1 lifting an EUR-pallet 21, as seen in an isometric view.

In this embodiment the pallet handling system 1 comprises a pallet rack 2 having three parallel support means 3, 4, 5 each having an upper support surface 6 being substantially vertically level—i.e. the upper support surface 6 or surfaces 6 of each of the three support means 3, 4, 5 are arranged in substantially the same height above ground level. In this embodiment an automated guided vehicle 10 (AGV) comprising a pallet lifting device 11, is about to lower and thereby place a standardized EUR-pallet 21 on the pallet rack 2 so that a first runner bottom deck 24 of a first runner 23a of the pallet 21 will rest on first support means 3 of the pallet rack 2, a second runner bottom deck 28 of a second runner 2a7 of the pallet 21 will rest on second support means 4 and a third runner bottom deck 26 of a third runner 25a of the pallet 21 will rest on third support means 5. I.e., in this embodiment the second support means 4 are located substantially exactly in the middle between the first support means 3 and the third support means 5 so that the three support means 3, 4, 5 may provide even and uniform support to a standard EUR-pallet 21 with the second runner 27 a located substantially exactly in the middle between the first runner 23a and the third runner 25a with the second runner 27a when the second runner 27 a of the EUR-pallet 21 is aligned with and placed on top of the second support means 4 of the pallet rack 2.

Nominal dimensions of an EUR-pallet 21 are 800 mm wide, 1,200 mm long and 144 mm high and it comprises three runners 23a, 25a, 27a of which at least the bottom decks 24, 26, 28 are extending the entire longitudinal length of the pallet 21. The two outer runners (i.e. the first runner 23a and the third runner 25 a) are 100 mm wide and the middle runner (i.e. the second runner 27a) is 145 mm wide. These measurements are the standard measurements for a EUR-pallet, however it is obvious that these dimensions may vary at least slightly due to manufacturing inaccuracies, deformation during use, wear, thermal expansion and other. The pallet 21 is typically made of wood, but it may also be made of plastic, metal, compressed cardboard, a composite material or any combination thereof.

FIG. 2 illustrates the pallet handling system 1 disclosed in FIG. 1 lifting a US-pallet 21, as seen in an isometric view.

In this embodiment the pallet lifting device 11 of the AGV 10 is about to lower a US pallet 21 down onto the three support means 3, 4, 5 of the pallet rack 2 so that the three bottom decks 24, 26, 28 each are supported by all three support means 3, 4, 5.

The standard US-pallet 21—often also called North America pallets-is nominally 40″ wide, 48″ long and 5.55″ high which approximately is 1016 mm wide, 1219 mm long and 141 mm high. The US-pallet design differs from the EUR-pallet design in several ways but a major difference is that although the US-pallet 21 comprises three runners 23b, 25b, 27b-often called stingers particularly on US-pallets-extending in the longitudinal extent of the pallet 21, the three bottom decks 24, 26, 28 are arranged perpendicular to the three runners 23b, 25b, 27b. The above measurements are the standard measurements for the most commonly used North American pallet 21, however it is obvious that these dimensions may vary at least slightly due to manufacturing inaccuracies, deformation during use, wear, thermal expansion and other.

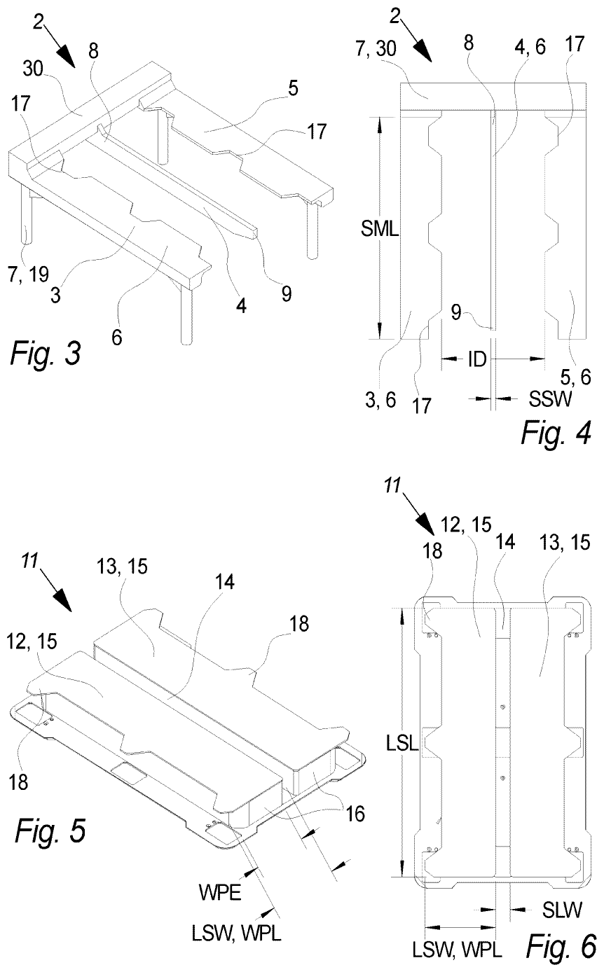

FIG. 3 illustrates a pallet rack 2, as seen in an isometric view and FIG. 4 illustrates a pallet rack 2, as seen from the top.

To enable that an EUR-pallet placed with the runners 23a, 25a, 27a parallel with the three support means 3, 4, 5 on the pallet rack 2 can be supported so that the first runner bottom deck 24 is in contact with the first support means 3 while the third runner bottom deck 26 is in contact with the third support means 5 the minimum internal distance ID between the first support means 3 and the third support means 5 is in approximately 640 mm to enable that most of the two outer runners 23 a, 25 a are supported by the two outer support means 3, 5. However, in another embodiment the width distance ID between the first 3 and third support means 5 could be wider such as 660 mm, 700 mm, 720 mm or even more or smaller such as 630 mm, 615 mm, 610 mm or even less.

In this embodiment the two outer support means 3, 5 have the same length SML of approximately 1,250 mm while the second support means 4 is a little shorter—i.e. approximately 1,200 mm. However, in another embodiment all three support means 3, 4, 5 could be the same length or the two outer support means 3, 5 could have different lengths SML. Also in another embodiment the two outer support means 3, 5 and/or the second support means 4 could be shorter—such as 1,100 mm, 1,000 mm, 900 mm or even shorter and/or the two outer support means 3, 5 and/or the second support means 4 could be longer—such as 1,300 mm, 1,350 mm, 1,400 mm or even longer e.g. dependent on the specific use, precision of the AVG 10 or other.

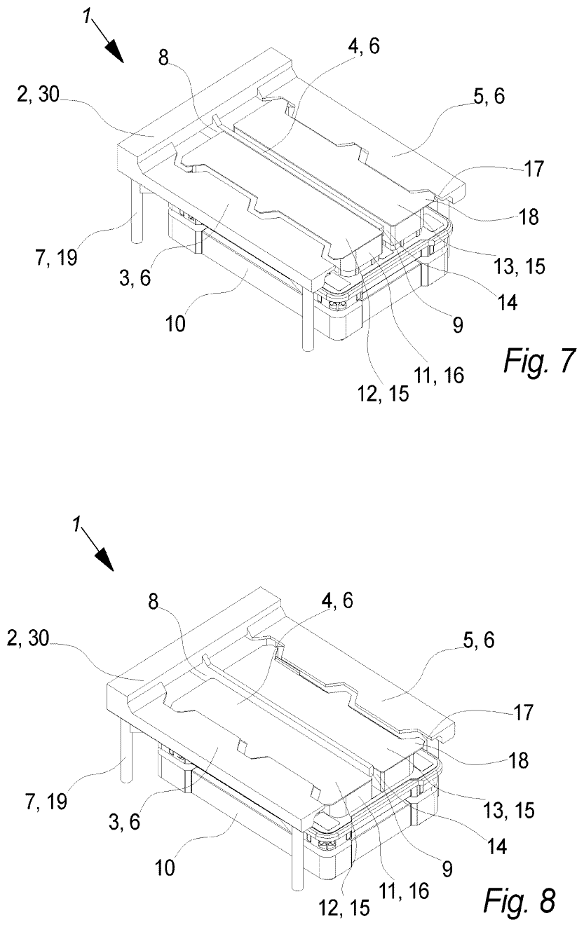

When the pallet 21 is transported around by the AGV 10 it is advantageous if the pallet 21 is supported by the pallet lifting device 11 as close to the outer periphery of the pallet 21 as possible to reduce the risk of the pallet 21 tipping of the AGV 10 during braking, acceleration or when driving through corners. Thus, in this embodiment the first support means 3 and the third support means 5 are each provided with three widthwise indentations 17 along the inside edge. As best seen in FIGS. 7 and 8 these indentations 17 enables that the two upper lifting surfaces 12, 13 of the pallet lifting device 11 can be provided with corresponding widthwise protrusions 18 extending into the widthwise indentations 17 enabling that the two outer runners 23a, 25a are supported by the two outer support means 3, 5 over almost the entire width of the runners 23a, 25a while at the same time ensuring that the two upper lifting surfaces 12, 13 of the pallet lifting device 11 at least in three areas are able to support the EUR-pallet 21 almost across the entire width of the runners 23 a, 25 a. However, in another embodiment, the inner edge of the first support means 3 and the third support means 5 could be straight—i.e. without indentations 17—or the first support means 3 and the third support means 5 could be provided with only one or two indentations 17 or the first support means 3 and the third support means 5 could be provided with more than three indentations 17—such as four, five, six or even more and/or the indentations could be provided with a different shape or size e.g. dependent on the specific use, the pallet types or other. If the first support means 3 and/or the third support means 5 are provided with another number of indentations 17 and/or indentations 17 of another size and/or shape it is advantageous if the widthwise protrusions 18 (see FIGS. 5-8) of the two upper lifting surfaces 12, 13 on the pallet lifting device 11 are altered similarly to substantially correspond to the indentations 17.

In this embodiment the three support means 3, 4, 5 are interconnected by means of an end bar 30 extending across the rack 2 at one end so that the three support means 3, 4, 5 are integrally formed. In this embodiment the pallet rack 2 further comprises a support structure 7 in the form of four legs 19 suspending the three interconnected support means 3, 4, 5 above the ground. However, in another embodiment the support structure 7 could comprise fewer or more legs 19 and/or the end bar 30 could be wall mounted, the outer support means could be individually connected to the underlying ground and the second support means 4 could comprise its own support structure 7 and/or the support structure 7 could be designed in numerous other ways and/or the three support means 3, 4, 5 could be connected to the support structure 7 in numerous other ways known to the skilled person.

In this embodiment the second support means 4 are formed as a lever having a second support connection end 8 being connected to the support structure 7 through the end bar 30 so that the second support means 4 has a second support free end 9 at the opposite end extending away from the end bar 30 enabling that the AGV including the lifting device 11 may travel in and out of the pallet rack 2 with a pallet 21 without being hindered by the support structure 7.

In this embodiment the second support means 4 has a width SSW of approximately 25 mm to ensure that the second runner 27a of an EUR pallet 21 is sufficiently supported while at the same time ensuring that both of the two upper lifting surfaces 12, 13 on the pallet lifting device 11 can make contact with the second runner 27a on either side of the second support means 4 when lifting the EUR-pallet of the pallet rack 2. However, in another embodiment the width SSW of the second support means 4 could be smaller—such as 22 mm, 19 mm, 16 mm or even smaller—or the width SSW could be greater—such as 30 mm, 40 mm, 50 mm or even greater—and/or the width SSW of the second support means 4 could vary along the longitudinal extent of the second support means 4.

FIG. 5 illustrates a pallet lifting device 11, as seen in an isometric view and FIG. 6 illustrates a pallet lifting device 11, as seen from the top.

In this embodiment the pallet lifting device 11 is a separate device connected to the top face of an AGV 10 but in another embodiment the pallet lifting device 11 could at least to some degree be formed integrally with the AGV 10.

In this embodiment the pallet lifting device 11 comprises first lifting means (not shown) arranged to actuate a first upper lifting surface 12 and second lifting means (not shown) arranged to actuate a second upper lifting surface 13 enabling that the two upper lifting surfaces 12, 13 can be actuated individually if needed but in another embodiment the two upper lifting surfaces 12, 13 could be actuated by the same drive means. In this embodiment the drive means comprises electrical actuators but in another embodiment the drive means could also or instead be hydraulic, pneumatic or other. In this embodiment each of the two upper lifting surfaces 12, 13 are formed by a wider lifting plate 15 placed on a narrower lifting pedestal 16, so that the maximum width WPL of the lifting plate 15 it greater than the maximum width WPE of the lifting pedestal 16. In this embodiment the width WPL of each of the lifting plates 15—and in this case thereby the width LSW of each of the upper lifting surfaces—is approximately 320 mm and the width WPE of each of the lifting pedestals 16 is approximately 240 mm but in another embodiment the lifting plates 15 and/or the lifting pedestals 16 could be wider or narrower e.g. depending on the specific use, the specific pallet rack design, the specific pallet to be handled or other. In another embodiment the pallet lifting device 11 could be formed without the lifting plates 15 or the lifting plates 15 could be formed integrally with the lifting pedestals 16.

In this embodiment two upper lifting surfaces 12, 13 are separated by a slit 14 extending along the middle of the pallet lifting device 11 wherein the slit 14 is arranged to accommodate the second support means 4 (see FIGS. 1, 2, and 7-10). In this embodiment the slit 14 has a width SLW of approximately 50 mm and the width is constant throughout the longitudinal extent. However, in another embodiment the slit 14 could be narrower—such as 45 mm, 35 mm, 25 mm or even narrower—or the slit 14 could be wider—such as 60 mm, 70 mm, 80 mm or even wider—and/or the width could vary throughout the longitudinal extent. Thus, in this embodiment the slit 14 is 25 mm wider than the second support means 4 disclosed in FIGS. 3 and 4 but in another embodiment the slit 14 would only be 20 mm, 15 mm, 10 mm or even less wider than the second support means 4 or the slit would be 30 mm, 40 mm, 50 mm or even more wider than the second support means 4.

In this embodiment the width LSW of each of the upper lifting surfaces 12, 13 are approximately 320 mm and the length LSL of each of the upper lifting surfaces 12, 13 are approximately 850 mm but in another embodiment the width LSW and/or the length LSL of one or both of the upper lifting surfaces 12, 13 could be greater or smaller e.g. dependent on the specific use, the specific AGV, the specific pallet rack design or other. Or in another embodiment the upper lifting surfaces 12, 13 could be formed as more than two upper lifting surfaces 12, 13—such as four, six, eight or even more.

FIG. 7 illustrates a pallet handling system 1 with a pallet lifting device 11 in lifted position, as seen in an isometric view, and FIG. 8 illustrates a pallet handling system 1 with a pallet lifting device 11 in lowered position, as seen in an isometric view.

In this embodiment the pallet handling system 1 is the same pallet handling system 1 as illustrated in all the other figures, but in these illustrations, it is easier to see how the how slit 14 is accommodating the second support means 4 and how the widthwise protrusions 18 of each of the upper lifting surfaces 12, 13 are extending into the corresponding widthwise indentations 17 of the two outer support means 3, 5.

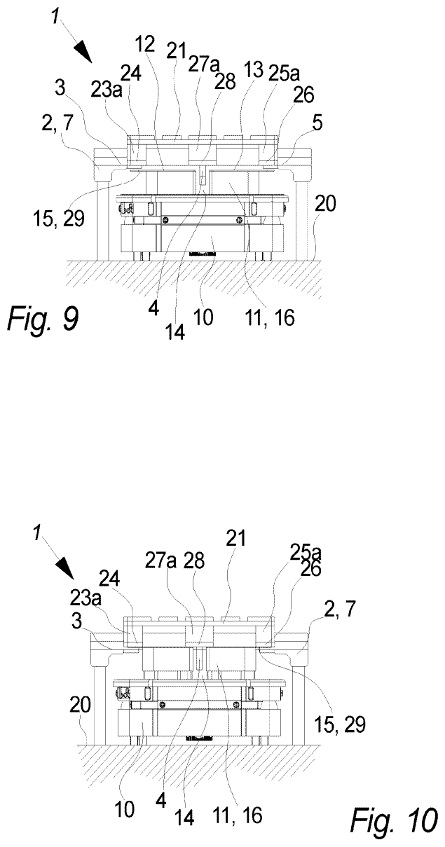

FIG. 9 illustrates a pallet handling system 1 with an EUR-pallet 21 in lowered position, as seen from the front, and FIG. 10 illustrates a pallet handling system 1 with an EUR-pallet 21 in lifted position, as seen from the front.

In this embodiment a pallet 21—in this case a EUR-pallet—comprising three bottom decks 22 is first placed on the pallet rack 2 to suspend the pallet 21 above ground level 20 and so that the three bottom deck 22 are supported by the three substantially level support means 3, 4, 5 of the pallet rack 2. After the pallet 21 is placed on the rack 2 the automated guided vehicle 10 comprising the pallet lifting device 11 is guided in under the pallet 21 supported by the pallet rack 2 in a direction substantially parallel with the longitudinal direction if the three support means 3, 4, 5. Once in place under the pallet 21, the upper lifting surfaces 12, 13 of the pallet lifting device 11 are raised up between the three support means 3, 4, 5 so that the upper lifting surfaces 12, 13 makes contact with the three bottom decks 22 of the pallet 21 and lifts the pallet 21 of the support means 3, 4, 5 and so that the slit 14 of the pallet lifting device 11 is accommodating the second support means 4 of the pallet rack 2. After this the automated guide vehicle 10 lifting the pallet 21 is guided away from the pallet rack 2 by moving forward (i.e. through the pallet rack 2) or backwards parallel with the direction it entered the pallet rack 2. The AGV 10 holding the pallet 21 can now move the pallet 21 to a new location.

Since the pallet 21 in this embodiment is an EUR-pallet 21, the pallet 21 is in this embodiment placed so that the second runner bottom deck 28 is aligned with and placed on top of the second support means 4 to enable that that the bottom decks 24, 26, 28 of all three runners 23a, 25a, 27a are supported by the three support means 3, 4, 5 when the pallet 21 is placed on the pallet rack 2 and by the upper lifting surfaces 12, 13 when the pallet is lifted of the pallet rack 2 by the pallet lifting devices 11. Thus, in this embodiment both the first upper lifting surface 12 and the second upper lifting surface 13 makes contact with the second runner bottom deck 28 when the first upper lifting surface 12 and the second upper lifting surface 13 are raised. However, in another embodiment the second support means 4 and/or the slit 14 could be displaced to one side enabling that only one of the first upper lifting surface 12 and the second upper lifting surface 13 would make contact with the second runner bottom deck 28 when the first upper lifting surface 12 and the second upper lifting surface 13 are raised. Furthermore, if the pallet was a US-pallet 21 or another type of pallet 21 the pallet 21 could be placed and aligned differently to enable maximum support both on the pallet rack 2 and the AGV 10.

In this embodiment the upper lifting surfaces 12, 13 of the pallet lifting devices 11 are formed by lifting plates 15 and in this embodiment the upper lifting surfaces 13, 14 are raised until the bottom surfaces 29 of the lifting plates 15 are higher than the three level support means 3, 4, 5 before the automated guide vehicle 10 comprising the pallet lifting device 11 and the pallet 21 is guided away from the pallet rack 2 to enable the greater clearance between the lifting pedestals 16 (being narrower than the lifting plates 15) and the second support means 4. However, in another embodiment the pallet 21 could be lifted to any height above the three level support means 3, 4, 5 before the automated guide vehicle 10 is guided away from the pallet rack 2 In FIGS. 1, 2, 9 and 10 the pallets 21 are without any goods placed on the pallets 21. However, the purpose of the pallets 21 are to provide a standardized base on which various kinds of goods may be placed so that the pallet 21 including the goods may be transported around by standardized pallet handling means such as forklifts, pallet jacks, pallet trucks, AGVs and other and it is therefore obvious that goods can be placed on the pallets 21 during handling of the pallets 21 by the pallet handling system 1. The goods placed on the pallets 21 could in principle be almost anything having a size and a weight suited for pallet storage and transport—i.e., any kind of boxes goods, machine parts, food items or other.

The invention has been exemplified above with reference to specific examples of pallets racks 2, automated guided vehicles 10, pallet lifting devices 11 and other. However, it should be understood that the invention is not limited to the particular examples described above but may be designed and altered in a multitude of varieties within the scope of the invention as specified in the claims.

### List

1. Pallet handling system
2. Pallet rack
3. First support means
4. Second support means
5. Third support means
6. Upper support surface
7. Support structure
8 Second support connection end
9. Second support free end
10. Automated guided vehicle
11. Pallet lifting device
12. First upper lifting surface
13. Second upper lifting surface
14. Slit
15. Lifting plate
16. Lifting pedestal
17. Widthwise indentation in first support means and third support means
18. Widthwise protrusions of upper lifting surface
19. Leg
20. Ground level
21. Pallet
22. Bottom deck
23a. First runner on EUR-pallet
23b. First runner on US-pallet
24. First runner bottom deck
25b. Third runner on EUR-pallet
25b. Third runner on US-pallet
26. Third runner bottom deck
27a. Second runner on EUR-pallet
27b. Second runner on US-pallet
28. Second runner bottom deck
29. Bottom surface of lifting plate
30. End bar
SSW. Width of second support means
SLW. Width of slit
ID. Internal distance between first and third support means
SML. Length of support means
LSW. Width of upper lifting surface
LSL. Length of upper lifting surface
WPL. Width of lifting plate
WPE. Width of lifting pedestal

1. A pallet handling system comprising:
a pallet rack comprising supports arranged in parallel along a longitudinal dimension thereof wherein each of the supports comprises one or more upper support surfaces that is substantially horizontally level relative to a ground surface, wherein the supports are connected to one or more support structures configured to hold the supports above the ground surface, wherein the supports comprise a first support, a second support, and a third support, wherein the second support is between the first support and the third support, wherein the second support comprises a lever having a support connection end connected to at least one of the one or more support structures and a support-free end, and wherein the second support has a width of between 5 millimeters (mm) and 140mm; and
an automated guided vehicle comprising a pallet lifting device, the pallet lifting device comprising at least two upper lifting surfaces, wherein the at least two upper lifting surfaces are separated by a slit along a middle part of the pallet lifting device so that a first upper lifting surface of the at least two upper lifting surfaces fits between the first support and the second support and so that a second upper lifting surface of the at least two upper lifting surfaces fits between the second support and the third support, and wherein the slit is configured to accommodate the second support.

2. The pallet handling system of claim 1, wherein the slit has a width that is between 5 mm and 140 mm and, wherein the slit is wider than the second support.

3. The pallet handling system of claim 1, wherein an internal distance between the first support and the third support is between 605 mm and 780 mm.

4. The pallet handling system of claim 1, wherein a length of each support is between 700 mm and 1,600 mm.

5. The pallet handling system of claim 1, wherein a width of each of the upper lifting surfaces is between 255 mm and 385 mm; and
wherein a length of each of the upper lifting surfaces is between 200 mm and 1,400 mm, where the length is measured along a longitudinal dimension of the supports and the width is perpendicular to the length.

6. The pallet handling system of claim 1, wherein the second support is a middle between the first support and the third support.

7. The pallet handling system of claim 1, wherein each of the least two upper lifting surfaces comprises a lifting plate on a lifting pedestal, and wherein a maximum width of the lifting plate is greater than a maximum width of the lifting pedestal.

8. The pallet handling system of claim 1, wherein the first support and the third support each comprises one or more widthwise indentations at sides thereof facing each other, and wherein the least two upper lifting surfaces comprise one or more widthwise protrusions extending into corresponding ones of the one or more widthwise indentations.

9. The pallet handling system of claim 1, wherein the supports are interconnected by the one or more support structures.

10. The pallet handling system of claim 1, wherein the supports are integrally formed, and wherein the one or more support structures comprise legs holding the supports above the ground surface.

11. A method for handling pallets, the method comprising:
placing a pallet comprising bottom decks on a pallet rack so that the bottom decks are supported above a ground surface by supports of the pallet rack, wherein the supports are parallel in a longitudinal dimension thereof, wherein the supports comprise a first support, a second support, and a third support, wherein the second support is between the first support and the third support, wherein the second support comprises a lever comprising a support connection end connected to at one or more support structures and a support-free end, and wherein the second support has a width of between 5 millimeters (mm) and 140 mm;
guiding an automated guided vehicle comprising a pallet lifting device under the pallet supported by the pallet rack in a direction substantially parallel to the longitudinal dimension;
raising a first upper lifting surface of the pallet lifting device up between the first support and the second support and raising a second upper lifting surface of the pallet lifting device up between the second support and the third support so that the first upper lifting surface and the second upper lifting surface make contact with the bottom decks of the pallet and lift the pallet; and
guiding the automated guide vehicle comprising the pallet lifting device holding the pallet away from the pallet rack in a direction substantially parallel with the longitudinal dimension.

12. The method of claim 11, wherein the pallet comprises a first runner having a first runner bottom deck extending along a first side of the pallet, a third runner having a third runner bottom deck extending along an opposite side of the pallet as the first runner bottom deck, and a second runner having a second runner bottom deck extending along a middle of the pallet parallel to the first runner bottom deck and the third runner bottom deck, and wherein the pallet is placed on the pallet rack with the second runner bottom deck aligned with, and on top of, the second support.

13. The method of claim 12, wherein both the first upper lifting surface and the second upper lifting surface make contact with the second runner bottom deck when the first upper lifting surface and the second upper lifting surface are raised relative to the ground surface.

14. The method of claim 11, wherein each of the at least two upper lifting surfaces comprise a lifting plate on a lifting pedestal, wherein a maximum width of the lifting plate is greater than a maximum width of the lifting pedestal, and wherein the first upper lifting surface and the second upper lifting surface are raised relative to the ground surface until bottom surfaces of the lifting plates are higher than the supports before guiding the automated guide vehicle away from the pallet rack.

15. (canceled)

16. A pallet handling system comprising:
a pallet rack comprising supports that are parallel along a longitudinal dimension thereof, wherein each of the supports comprises one or more upper support surfaces that is substantially horizontally level relative to a ground surface, and wherein the supports are connected to one or more support structures configured to hold the supports above the ground surface; and
an automated guided vehicle comprising a pallet lifting device comprising an upper lifting surface;
wherein each of the supports comprises one or more widthwise indentations on sides thereof facing each other, and wherein an edge of the upper lifting surface comprises one or more widthwise protrusions that are extendable into one or more corresponding widthwise indentations.

17. The pallet handling system of claim 16, wherein the pallet lifting device comprises at least two of upper lifting surfaces.

18. The pallet handling system of claim 16, wherein the supports comprise two supports.

19. The pallet handling system of claim 1, wherein the supports comprise three supports.

20. The pallet handling system of claim 1, wherein the second support has a width between 20 mm and 120 mm.

21. The pallet handling system of claim 2, wherein the slit has a width that is between 10 mm and 120 mm.

22. The pallet handling system of claim 3, wherein the internal distance is between 620 mm and 750 mm.

23. The pallet handling system of claim 4, wherein the length of each support is between 800 mm and 1,300 mm.

24. The pallet handling system of claim 5, wherein a width of each of the upper lifting surfaces is between 280 mm and 360 mm; and
wherein a length of each of the upper lifting surfaces is between 500 mm and 1,200 mm.

25. The method of claim 11, wherein the second support means has a width between 20 mm and 120 mm.
